(19) United States
(12) Patent Application Publication
(10) Pub. No.: US 2025/0260541 A1
(43) Pub. Date: Aug. 14, 2025

(54) TECHNIQUES FOR PROVIDING CHANNEL STATE INFORMATION REPORT INFORMATION

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Hamed PEZESHKI, San Diego, CA (US); Tao LUO, San Diego, CA (US)

(21) Appl. No.: 18/857,588

(22) PCT Filed: Jul. 7, 2022
(86) PCT No.: PCT/CN2022/104286

§ 371 Date: Oct. 17, 2024

(51) Int. Cl. H04L 5/00; H04W 24/10

(52) U.S. Cl. CPC H04L 5/0053; H04L 5/0091; H04W 24/10

(57) ABSTRACT

Various aspects of the present disclosure generally relate to wireless communication. In some aspects, a user equipment (UE) may receive an indication of an amount of information to provide in a channel state information (CSI) report, the indication comprising an implicit indication of the amount of information, wherein the implicit indication comprises an indication of a communication parameter that does not schedule the CSI report. The CE may transmit the CSI report having the amount of information as indicated by the implicit indication. Numerous other aspects are described.

### FIELD OF THE DISCLOSURE

Aspects of the present disclosure generally relate to wireless communication and to techniques and apparatuses for providing channel state information report information.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

Some aspects described herein relate to a method of wireless communication performed by a user equipment (UE). The method may include receiving an indication of an amount of information to provide in a channel state information (CSI) report, the indication comprising an implicit indication of the amount of information in a first message that is different from a second message that schedules transmission of the CSI report. The method may include transmitting the CSI report having the amount of information as indicated by the implicit indication.

Some aspects described herein relate to a method of wireless communication performed by a network node. The method may include transmitting an indication of an amount of information to provide in a CSI report, the indication comprising an implicit indication of the amount of information in a first message that is different from a second message that schedules transmission of the CSI report. The method may include receiving, from a UE, the CSI report having the amount of information as indicated by the implicit indication.

Some aspects described herein relate to a UE for wireless communication. The UE may include a memory and one or more processors coupled to the memory. The one or more processors may be configured to receive an indication of an amount of information to provide in a CSI report, the indication comprising an implicit indication of the amount of information in a first message that is different from a second message that schedules transmission of the CSI report. The one or more processors may be configured to transmit the CSI report having the amount of information as indicated by the implicit indication.

Some aspects described herein relate to a network node for wireless communication. The network node may include a memory and one or more processors coupled to the memory. The one or more processors may be configured to transmit an indication of an amount of information to provide in a CSI report, the indication comprising an implicit indication of the amount of information in a first message that is different from a second message that schedules transmission of the CSI report. The one or more processors may be configured to receive, from a UE, the CSI report having the amount of information as indicated by the implicit indication.

Some aspects described herein relate to a non-transitory computer-readable medium that stores a set of instructions for wireless communication by a UE. The set of instructions, when executed by one or more processors of the UE, may cause the UE to receive an indication of an amount of information to provide in a CSI report, the indication comprising an implicit indication of the amount of information in a first message that is different from a second message that schedules transmission of the CSI report. The set of instructions, when executed by one or more processors of the UE, may cause the UE to transmit the CSI report having the amount of information as indicated by the implicit indication.

Some aspects described herein relate to a non-transitory computer-readable medium that stores a set of instructions for wireless communication by a network node. The set of instructions, when executed by one or more processors of the network node, may cause the network node to transmit an indication of an amount of information to provide in a CSI report, the indication comprising an implicit indication of the amount of information in a first message that is different from a second message that schedules transmission of the CSI report. The set of instructions, when executed by one or more processors of the network node, may cause the network node to receive, from a UE, the CSI report having the amount of information as indicated by the implicit indication.

Some aspects described herein relate to an apparatus for wireless communication. The apparatus may include means for receiving an indication of an amount of information to provide in a CSI report, the indication comprising an implicit indication of the amount of information in a first message that is different from a second message that schedules transmission of the CSI report. The apparatus may include means for transmitting the CSI report having the amount of information as indicated by the implicit indication.

Some aspects described herein relate to an apparatus for wireless communication. The apparatus may include means for transmitting an indication of an amount of information to provide in a CSI report, the indication comprising an implicit indication of the amount of information in a first message that is different from a second message that schedules transmission of the CSI report. The apparatus may include means for receiving, from a UE, the CSI report having the amount of information as indicated by the implicit indication.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network.

FIG. 2 is a diagram illustrating an example of a network node in communication with a user equipment (UE) in a wireless network.

FIG. 3 is a diagram illustrating an example disaggregated base station architecture, in accordance with the present disclosure.

FIG. 4 is a diagram illustrating examples of channel state information reference signal (CSI-RS) beam management procedures, in accordance with the present disclosure.

FIG. 5 is a diagram illustrating an example of a beam prediction procedure, in accordance with the present disclosure.

FIG. 6 is a diagram of an example associated with providing channel state information report information, in accordance with the present disclosure.

FIG. 7 is a diagram illustrating an example process performed, for example, by a UE, in accordance with the present disclosure.

FIG. 8 is a diagram illustrating an example process performed, for example, by a network node, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

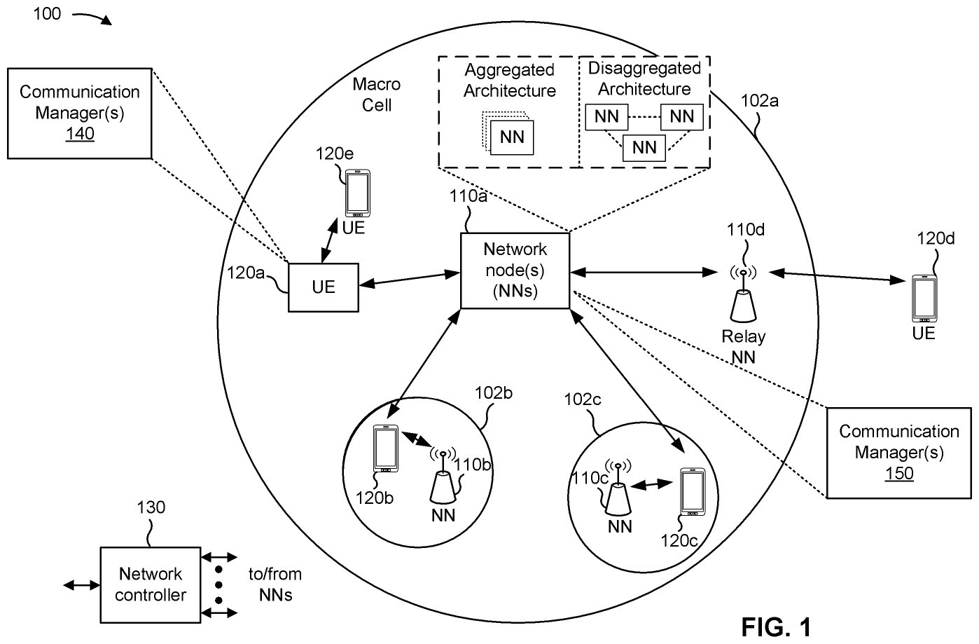

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With these examples in mind, unless specifically stated otherwise, the term “sub-6 GHZ,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive an indication of an amount of information to provide in a CSI report, the indication comprising an implicit indication of the amount of information in a first message that is different from a second message that schedules transmission of the CSI report; and transmit the CSI report having the amount of information as indicated by the implicit indication. Additionally, or alternatively, the communication manager 140 may perform one or more other operations described herein.

In some aspects, the network node 110 may include a communication manager 150. As described in more detail elsewhere herein, the communication manager 150 may transmit an indication of an amount of information to provide in a CSI report, the indication comprising an implicit indication of the amount of information, the indication comprising an implicit indication of the amount of information in a first message that is different from a second message that schedules transmission of the CSI report; and receive, from a UE, the CSI report having the amount of information as indicated by the implicit indication. Additionally, or alternatively, the communication manager 150 may perform one or more other operations described herein.

As indicated above, FIG. 1 is provided as an example. Other examples may differ from what is described with regard to FIG. 1.

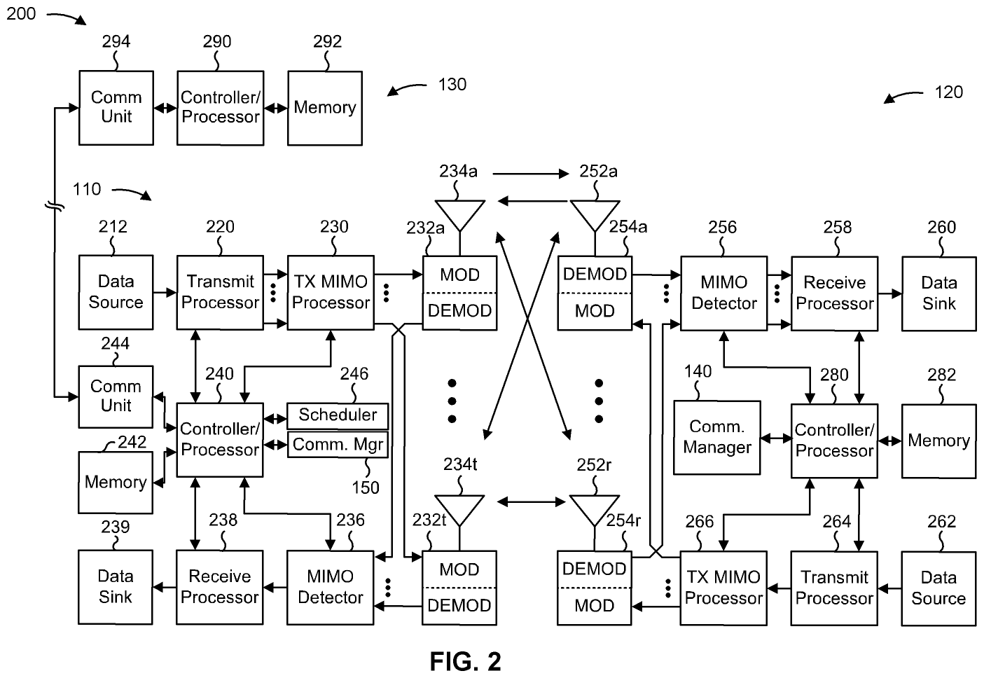

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

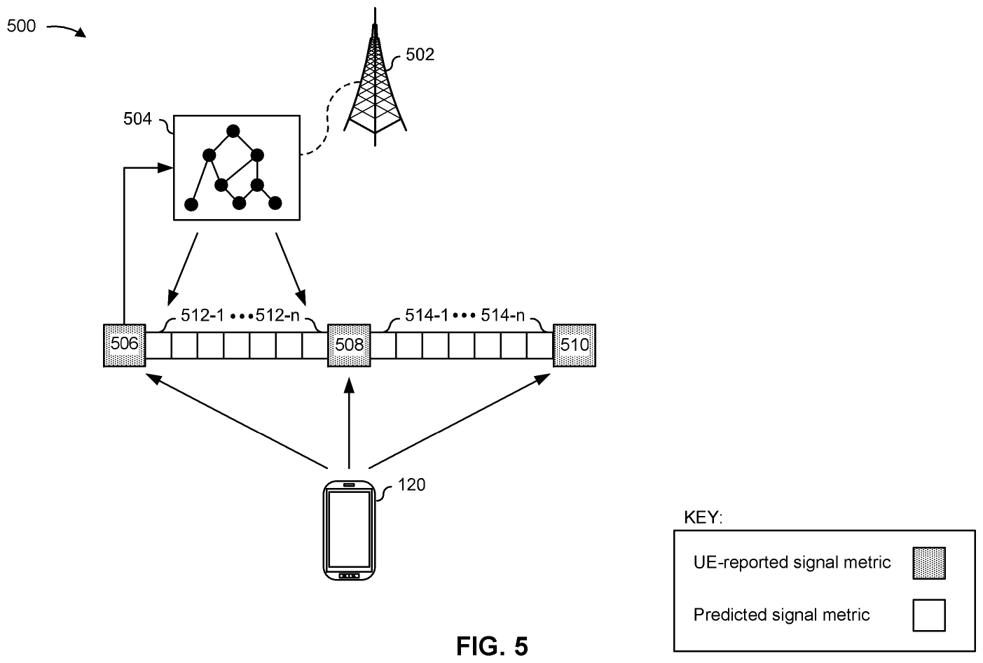

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 5-10).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIGS. 5-10).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

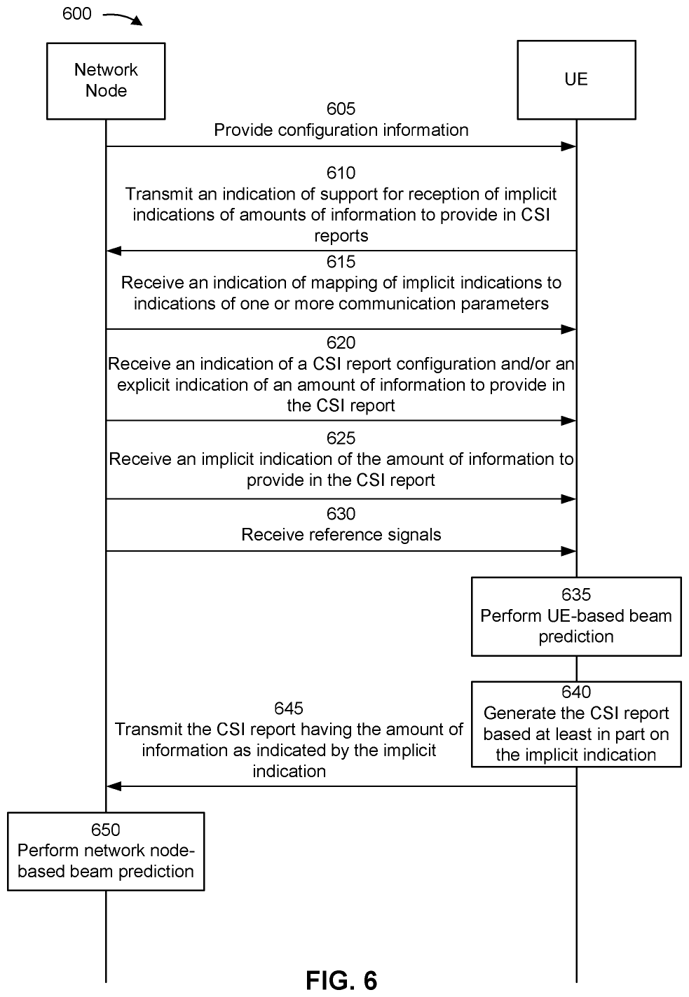

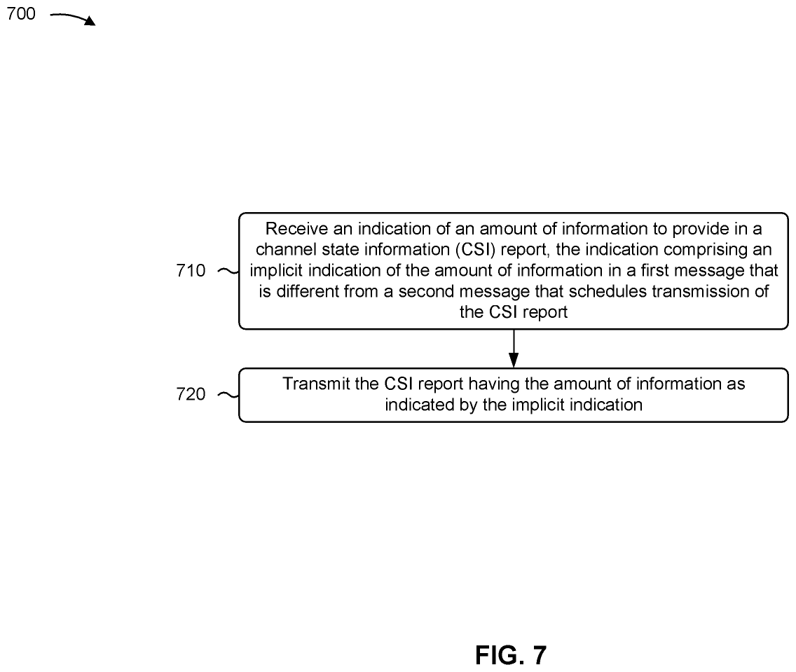

The controller/processor 240 of the network node 110, the controller/processor 280 of the UE 120, or any other component(s) of FIG. 2 may perform one or more techniques associated with providing channel state information report information, as described in more detail elsewhere herein. For example, the controller/processor 240 of the network node 110, the controller/processor 280 of the UE 120, or any other component(s) (or combinations of components) of FIG. 2 may perform or direct operations of, for example, process 600 of FIG. 6, process 700 of FIG. 7, and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, a UE (e.g., the UE 120) includes means for receiving an indication of an amount of information to provide in a CSI report, the indication comprising an implicit indication of the amount of information in a first message that is different from a second message that schedules transmission of the CSI report; and/or means for transmitting the CSI report having the amount of information as indicated by the implicit indication. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for transmitting an indication of an amount of information to provide in a CSI report, the indication comprising an implicit indication of the amount of information in a first message that is different from a second message that schedules transmission of the CSI report; and/or means for receiving, from a UE, the CSI report having the amount of information as indicated by the implicit indication. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

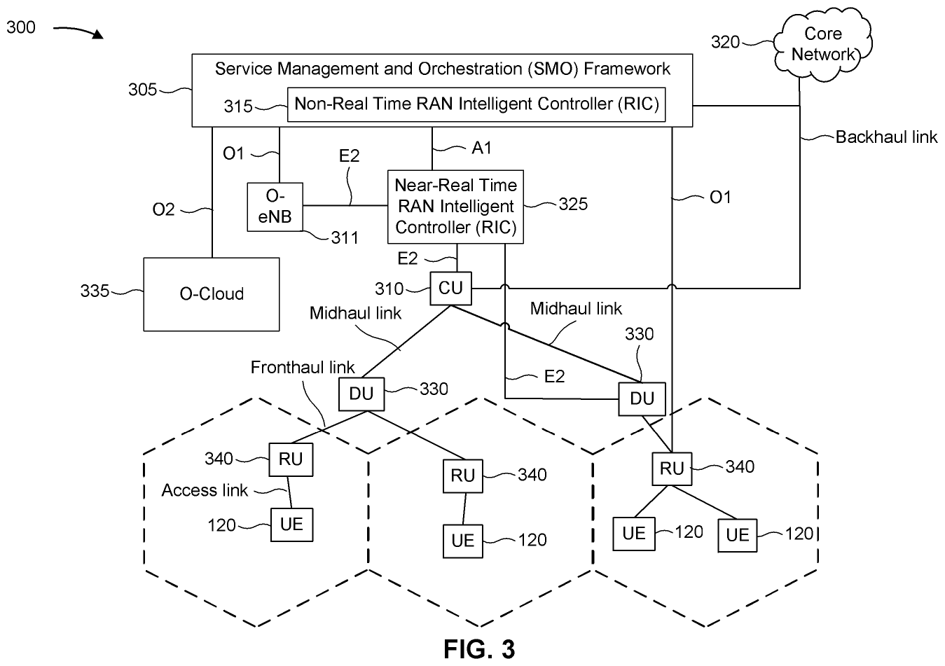

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 335) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

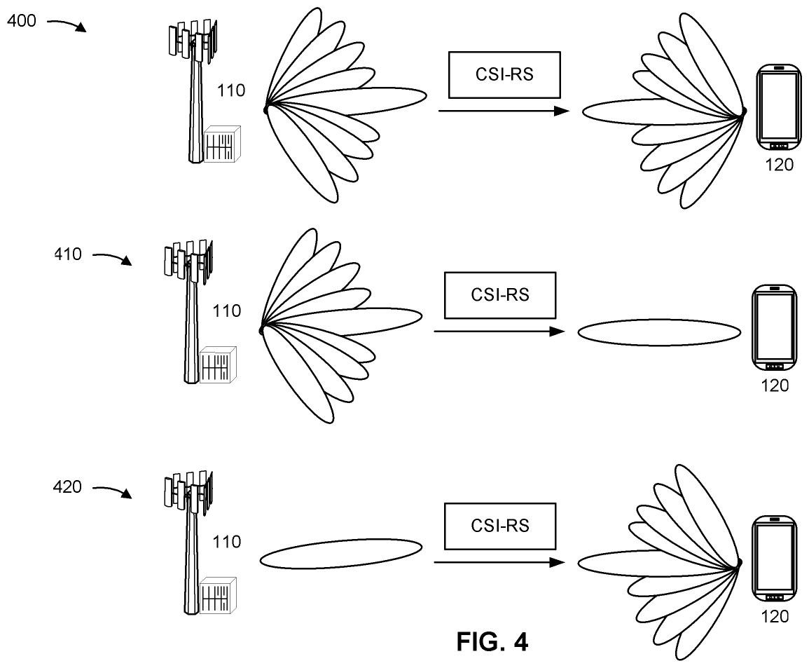

FIG. 4 is a diagram illustrating examples 400, 410, and 420 of channel state information reference signal (CSI-RS) beam management procedures, in accordance with the present disclosure. As shown in FIG. 4, examples 400, 410, and 420 include a UE 120 in communication with a network node 110 in a wireless network (e.g., wireless network 100). However, the devices shown in FIG. 4 are provided as examples, and the wireless network may support communication and beam management between other devices (e.g., between a UE 120 and a network node 110 or transmit receive point (TRP), between a mobile termination node and a control node, between an integrated access and backhaul (IAB) child node and an IAB parent node, and/or between a scheduled node and a scheduling node). In some aspects, the UE 120 and the network node 110 may be in a connected state (e.g., an RRC connected state).

As shown in FIG. 4, example 400 may include a network node 110 (e.g., one or more network node devices such as an RU, a DU, and/or a CU, among other examples) and a UE 120 communicating to perform beam management using CSI-RSs. Example 400 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 4 and example 400, CSI-RSs may be configured to be transmitted from the network node 110 to the UE 120. The CSI-RSs may be configured to be periodic (e.g., using RRC signaling), semi-persistent (e.g., using media access control (MAC) control element (MAC-CE) signaling), and/or aperiodic (e.g., using downlink control information (DCI)).

The first beam management procedure may include the network node 110 performing beam sweeping over multiple transmit (Tx) beams. The network node 110 may transmit a CSI-RS using each transmit beam for beam management. To enable the UE 120 to perform receive (Rx) beam sweeping, the network node may use a transmit beam to transmit (e.g., with repetitions) each CSI-RS at multiple times within the same reference signal resource set so that the UE 120 can sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 400 has been described in connection with CSI-RSs, the first beam management procedure may also use synchronization signal blocks (SSBs) for beam management in a similar manner as described above.

As shown in FIG. 4, example 410 may include a network node 110 and a UE 120 communicating to perform beam management using CSI-RSs. Example 410 depicts a second beam management procedure (e.g., P2 CSI-RS beam management). The second beam management procedure may be referred to as a beam refinement procedure, a network node beam refinement procedure, a TRP beam refinement procedure, and/or a transmit beam refinement procedure. As shown in FIG. 4 and example 410, CSI-RSs may be configured to be transmitted from the network node 110 to the UE 120. The CSI-RSs may be configured to be aperiodic (e.g., using DCI). The second beam management procedure may include the network node 110 performing beam sweeping over one or more transmit beams. The one or more transmit beams may be a subset of all transmit beams associated with the network node 110 (e.g., determined based at least in part on measurements reported by the UE 120 in connection with the first beam management procedure). The network node 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the network node 110 to select a best transmit beam based at least in part on measurements of the CSI-RSs (e.g., measured by the UE 120 using the single receive beam) reported by the UE 120.

As shown in FIG. 4, example 420 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 4 and example 420, one or more CSI-RSs may be configured to be transmitted from the network node 110 to the UE 120. The CSI-RSs may be configured to be aperiodic (e.g., using DCI). The third beam management procedure may include the network node 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the network node may use a transmit beam to transmit (e.g., with repetitions) CSI-RSs at multiple times within the same reference signal resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the network node 110 and/or the UE 120 to select a best receive beam based at least in part on reported measurements received from the UE 120 (e.g., of the CSI-RS of the transmit beam using the one or more receive beams).

As indicated above, FIG. 4 is provided as an example of beam management procedures. Other examples of beam management procedures may differ from what is described with respect to FIG. 4. For example, the UE 120 and the network node 110 may perform the third beam management procedure before performing the second beam management procedure, and/or the UE 120 and the network node 110 may perform a similar beam management procedure to select a UE transmit beam.

FIG. 5 is a diagram illustrating an example 500 of a beam prediction procedure, in accordance with the present disclosure.

Beam management procedures may improve communications in a wireless network by providing a network node and/or a UE with a mechanism to identify beams with better signal quality relative to other beams. Communicating via the wireless network using beams with better signal quality may reduce recovery errors at a receiver, increase data throughput, and/or reduce data-transfer latencies (e.g., by reducing retransmissions) relative to the other beams. Various factors may cause the network node and UE to perform the beam management procedures multiple times, such as atmospheric changes, the UE moving to a new location, and/or changes in interference associated with other devices. The repeated beam management procedures may consume air interface resources (e.g., frequency resources and/or time resources) that the wireless network could otherwise direct to additional devices or use for other transmissions. Thus, the repeated beam management procedures may increase data-transfer latencies for other devices while the network node and the UE perform each beam management procedure.

To reduce signaling overhead and resource consumption associated with beam management procedures, a network node 502 (shown in the example 500 as a base station) may select a beam and/or beam pairs based at least in part on prediction algorithms. For example, the network node 502 may include one or more modules 504 that are trained using a machine learning algorithm (e.g., a deep neural network (DNN) algorithm, a long short-term memory (LSTM) network algorithm, a gradient boosted algorithm, a K-means algorithm, and/or a random forest algorithm). Machine learning involves computers learning from data to perform tasks. As one example, machine learning algorithms are used to train machine learning models based at least in part on sample data, known as “training data.” Once trained, machine learning models may be used to make predictions, decisions, or classifications relating to new observations. In some aspects, the module(s) 504 may be trained to predict a signal metric (e.g., a signal-to-interference-plus-noise ratio (SINR) metric and/or an RSRP metric). Alternatively or additionally, the module(s) 504 may be trained to predict a beam and/or beam pair based at least in part on a signal metric (e.g., a UE-generated signal metric and/or a predicted signal metric).

To illustrate, the network node 502 may periodically receive a UE-reported signal metric (e.g., from the UE 120), as shown by reference number 506, reference number 508, and reference number 510. As one example, the network node 502 may receive, as a UE-reported signal metric, a layer 1 RSRP (L1-RSRP) metric and/or a layer 1 SINR (L1-SINR) metric from the UE 120 every 120 milliseconds (msec). The module(s) 504 may receive the UE-reported signal metric as input, and predict one or more signal metrics and/or one or more beam configurations at various points in time as shown by reference number 512-1 to reference number 512-n (where n is an integer). For instance, the module(s) 504 may use the UE-reported signal metric shown by reference number 506 to predict a set of future signal metrics and/or a set of future beam configurations at a periodicity of 20 msec. The module(s) 504 may iteratively receive UE-reported signal metrics as shown by reference number 508 and reference number 510 as feedback for subsequent predictions. To illustrate, the module(s) 504 may use the UE-reported signal metric shown by reference number 508 and/or the UE-reported signal metric shown by reference number 506 to predict signal metrics as shown by reference number 514-1 to reference number 514-n. The module(s) 504 may alternatively or additionally select a beam and/or beam pair that is predicted to have better performance (e.g., improved signal quality, reduced recovery errors, and/or increased data throughput) relative to other beams. To preserve air interface resources, the UE 120 may be configured to refrain from reporting a signal metric in between the configured reporting periods, as shown by reference number 506, reference number 508, and reference number 510.

As indicated above, FIG. 5 is provided as an example. Other examples may differ from what is described with regard to FIG. 5.

In some networks, as described in connection with FIG. 5, a network node performs beam prediction based at least in part on reported metrics from a UE. In some networks, the UE may perform beam prediction and report a predicted beam to the network node. Some networks may be configured for either network-node-based beam prediction or UE-based beam prediction.

Network-node-based beam prediction may be limited by an amount of information that the UE provides in a CSI report or other report of metrics. For example, the limited amount of information may be based at least in part on a conservation of network resources that would be consumed by reporting a full set of measurements of reference signals by the UE. In an example network, the UE may report quantized L1-RSRPs associated with a top 2 strongest SSBs instead of reporting all 8 SSBs measured by the UE. This may result in performance degradation for beam prediction based at least in part on the network node having reduced information for the beam prediction. However, network-node-based beam prediction may conserve power and computing resources of the UE.

Alternatively, UE-based beam prediction may have access to more measurements without consuming overhead based at least in part on the UE observing the measurements. The UE may report one or more predicted beams and/or determine one or more beams that should be measured based at least in part on the UE-based beam prediction. However, the UE may consume computing and power resources to train a model for beam prediction.

In some networks, a UE may be configured with a number of SSBs to report (e.g., ReportQuantity ssb-Index-RSRP or ssb-Index-SINR or cri-RSRP or cri-SINR) for joint SSB resource index (SSBRI) CSI resource index (RI) and L1-RSRP/L1-SINR beam reporting. The UE may report a number of reported reference signals (e.g., nrofReportedRS). For example, the UE may be RRC-configured to report up to 2 or 4 reference signals (e.g., using different SSBRI or CRI, among other examples) for each configuration (e.g., (′SI-ReportConfig) based at least in part on a UE capability.

For L1-RSRP reporting, the UE may report a strongest SSBRI with 7 bits indicating RSRP in a range of [−140,−44] dBm with a 1 dBm step size. For remaining SSBRIs or CRIs, the UE may use 4 bits to report a differential RSRP in a range of [0,−30] dB with 2 dB step size and a reference to the strongest SSBRI or CRI L1-RSRP.

For the strongest SSBRI or CRI L1-RSRP, there are invalid code-points based at least in part on 2\hat{ }7=128 available code points with only 140−44+1=97 candidate RSRPs to report. Mapping between the reported 7-bit or 4-bit code-points and actually measured RSRP values is defined in a communication protocol (e.g., TS-38.133 Table 10.1.6.1-1 & Table 10.1.6.1-2).

For L1-SINR reporting, the UE may report a strongest SSBRI or CRI with 7 bits to indicate SINR in a range of [−23, 40] dB with 0.5 dB step size. For remaining SSBRIs or CRIs, the UE may use 4 bits to report a differential SINR in a range of [0,−15] dB with 1 dB step size and a reference to the strongest SSBRI or CRI L1-SINR.

For the strongest and the remaining SSBRIs or CRIs, there are no invalid code-points, but SINR_0 stands for SINR<−23 dB for the strongest SSBRI or CRI, while DIFFSINR_15 stands for ΔSINR≤−15 dB. Mapping between the reported 7-bit or 4-bit code-points and the actually measured SINR values is defined in the communication protocol (e.g., TS-38.133 Table 10.1.16.1-1 & Table 10.1.16.1-2).

In network node-based time domain beam prediction relying on UE-reported L1-RSRPs as inputs, an amount of information reported may be insufficient. More L1-RSRPs regarding remaining CSI-RS/SSB resources may be necessary to adequately predict beams. This may be impractical if the uplink coverage is limited or if the UE is not scheduled with sufficient uplink resources for such information.

Alternatively, although UE-based beam prediction does not require large amounts of L1-RSRPs to be reported, UE power is consumed as additional ML-models are deployed and operated at the UE in addition to beam management procedures. However, using UE-based beam prediction may allow for a reduction in a number of L1-RSRPs reported to the network node. In this case, the UE may report UE-predicted transmission and/or reception beams and associated L1-RSRPs.

In some aspects described herein, a UE and a network node may be configured to switch between UE-based beam prediction and network node-based beam prediction. Supporting dynamic switching between these two modes (network node-based beam prediction and UE-based beam prediction) is beneficial, considering different UE power saving modes, uplink coverage situations, and/or available UL resources.

In some aspects, switching may be indicated by different CSI report settings for periodic (P) and/or semi-persistent (SP) CSI reports, or by different CSI triggering configurations for aperiodic (AP) CSI reports.

Additionally, or alternatively, switching may be indicated implicitly through signaling associated with other types of dynamic changes. For example, an implicit indication may indicate whether to use UE-based beam prediction or network node-based beam prediction. Additionally, or alternatively, an implicit indication may indicate one or more parameters of UE-based beam prediction or network node-based beam prediction (e.g., in connection with a broad, explicit indication to use UE-based beam prediction or network node-based beam prediction). For example, the implicit indication of one or more parameters may indicate selection of one of a large number of reporting frameworks (or compression of the L1 report) to efficiently provide reports with different levels of overhead-performance tradeoffs. This may provide improved granularity of an amount of information to provide in a CSI report, relative to a legacy configuration of a CSI report based at least in part on RRC, MAC-CE, and/or DCI overhead restrictions. For example, in a legacy configuration of an SP CSI report activated by DCI, a total number of activatable SP CSI reports is limited by a number of CSI request bits (e.g., up to 6 bits) in an uplink grant DCI.

In some aspects described herein, an indication of an amount of information to include in a CSI report (e.g., associated with network node-based beam prediction or UE-based beam prediction) may be indicated via an explicit indication (e.g., within a CSI configuration message) and an implicit indication (e.g., in a message other than the CSI configuration message) to support switching between network node-based beam prediction and UE-based beam prediction with improved efficiency of the CSI report.

In some aspects, an explicit indication of an amount of information to include in a CSI report (e.g., associated with network node-based beam prediction or UE-based beam prediction) may be based at least in part on a type of CSI report. For example, for a P CSI report or an SP CSI report, the UE may be configured with at least 2 different CSI report settings that are associated with 2 different types of reporting frameworks. The first type of reporting framework is associated with reporting L1-RSRPs addressing at least a higher number of channel measurement resources (CMRs) and consumes higher reporting overhead, where UE-based beam prediction is not expected (e.g., where network node-based beam prediction is expected). The second type of reporting framework is associated with reporting L1-RSRPs addressing at least a lower number of CMRs and consumes lower reporting overhead, where UE side beam prediction is expected. The second reporting framework may be associated with reporting predicted L1-RSRPs addressing certain CMRs. Each type of reporting framework may comprise multiple sub-types of reporting frameworks.

For SP CSI reports, a MAC-CE activating the SP CSI report may indicate which specific type and/or sub-type should be used. For AP CSI reports, the CSI triggering state configurations associated with certain CSI report settings may indicate which specific type and/or sub-type should be used.

The UE may identify a proper reporting framework and/or an amount of information to provide in a CSI report based at least in part the P, SP, or AP CSI report being configured, activated, or triggered.

The different reporting frameworks may include different sub-type parameters. For example, the different reporting frameworks may be associated with parameters for a number of L1-RSRPs and associated number of CMR-IDs or CMR+Rx-beam-ID pairs. Additionally, or alternatively, the different reporting frameworks may be associated with parameters for L1-RSRP/L1-SINR quantization schemes, leading to different final payload sizes. For example, different quantization granularities, step-sizes, and/or dynamic ranges may be associated with different reporting frameworks. In some aspects, if differential quantization refers to another L1-RSRP or L1-SINR, different source L1-RSRP or L1-SINR options may be considered. In some aspects, L1 reporting comprising different compression schemes, with at least differences on payload size after compression, may be associated with different reporting frameworks.

In some aspects, the network node may transmit an implicit indication of an amount of data to include in the CSI report. The UE may be configured with a single CSI report setting to report at least L1-RSRPs or L1-SINRs associated with a number of channel measurement resources (e.g., CSI-RS or SSB resources). The UE may receive an indication of a dynamic mode switch (e.g., a mode for communication that indicates a configuration of another aspect of communication that is not CSI-RS reporting). The indication of the dynamic mode switch may be an implicit indication for the reporting framework for the CSI report. An association between a certain L1 reporting framework and a certain mode indicated by the dynamic mode switch may be indicated in a communication protocol and/or via RRC signaling prior to receiving the indication of the dynamic mode switch. If the association is configured by a network node, the association may be further based at least in part on an indication within a CSI report setting. In some aspects, the implicit indication may indicate any different sub-type parameters, such as those described herein.

In some aspects, the implicit indication may be based at least in part on a dynamic mode switch for a physical uplink shared channel (PUCCH) resource and/or PUCCH repetition factor, a dynamic switch between single-TRP operation mode and multi-TRP operation mode, and/or a dynamic switch between non-DRX and DRX (e.g., including DRX periodicity).

In some aspects, different L1 reporting framework options (e.g., amounts of information and/or types of information to include in the CSI report) may be associated with different PUCCH payload sizes and/or different PUCCH repetitions factors. In this way, the UE may determine the reporting framework based at least in part on the dynamically indicated PUCCH resource payload size and/or the associated repetition factor. For example, when a PUCCH repetition factor is larger than a threshold or when the PUCCH resource payload size is smaller than a threshold, the UE may use a reporting framework that uses fewer payload bits (e.g., L1 reporting for UE-based beam prediction). Alternatively, when a PUCCH repetition factor is lower than a threshold or when the PUCCH resource payload size is larger than a threshold, the UE may use a reporting framework that uses higher payload bits (e.g., L1 reporting for network node-based beam prediction).

In some aspects, different L1 reporting framework options may be associated with different single-TRP and multi-TRP operation modes. In this way, the UE may determine the reporting framework based at least in part on a dynamically indicated single-TRP or multi-TRP operation mode. For example, when a single-TRP operation mode is indicated, a reporting framework for UE-based beam prediction may be used (e.g., because the ML-model complexity for this is likely to be low). Alternatively, when a multi-TRP operation mode is indicated, a reporting framework for network node-based beam prediction should be used (e.g., because the ML-model complexity for this is likely to be high).

In some aspects, if the UE identifies decoded DCI during a DRX-On cycle (e.g., a network node indicates to schedule a physical downlink shared channel (PDSCH) and/or physical uplink shared channel (PUSCH) for the UE during the DRX-On cycle), applicable L1-RSRP reports until the next DRX-On cycle may be based at least in part on a framework for UE-based beam prediction. This may be based at least in part on an associated UE power budget for ML inference that may be higher if the network node intends to have more frequent communications with the UE. If the UE does not identify decoded DCI during the DRX-On cycle, the UE may use L1-RSRP reports that are based at least in part on network node-based beam prediction until a subsequent DRX-On cycle.

Based at least in part on supporting changing amounts of information to be included in a CSI report, a network may efficiently use network node-based beam prediction and UE-based beam prediction. In this way, the UE and the network node may conserve network resources that may have otherwise been used to avoid beam prediction, may conserve power resources that may have otherwise been unnecessarily used by statically configuring UE-side beam prediction, and/or may conserve network resources that may have otherwise been unnecessarily used by using network node-based beam prediction with reduced accuracy from having insufficient information from a UE.

FIG. 6 is a diagram of an example 600 associated with providing channel state information report information, in accordance with the present disclosure. As shown in FIG. 6, a network node (e.g., network node 110, a CU, a DU, and/or an RU) may communicate with a UE (e.g., UE 120). In some aspects, the network node and the UE may be part of a wireless network (e.g., wireless network 100). The UE and the network node may have established a wireless connection prior to operations shown in FIG. 6.

As shown by reference number 605, the network node may transmit, and the UE may receive, configuration information. In some aspects, the UE may receive the configuration information via one or more of RRC signaling, one or more medium access control (MAC) control elements (CEs), and/or DCI, among other examples. In some aspects, the configuration information may include an indication of one or more configuration parameters (e.g., already known to the UE and/or previously indicated by the network node or other network device) for selection by the UE, and/or explicit configuration information for the UE to use to configure the UE, among other examples.

In some aspects, the configuration information may indicate that the UE is to transmit an indication of support for UE-based beam prediction, network node-based beam prediction, switching between UE-based beam prediction and network node-based beam prediction, and/or receiving implicit indications of amounts of data to provide in CSI reports.

The UE may configure itself based at least in part on the configuration information. In some aspects, the UE may be configured to perform one or more operations described herein based at least in part on the configuration information.

As shown by reference number 610, the UE may transmit, and the network node may receive, an indication of support for reception of implicit indications of amounts of information to provide in CSI reports. In some aspects, the UE may indicate a mapping of the implicit indications to indications of one or more communication parameters (e.g., communication parameters other than a CSI reporting configuration). In some aspects, the UE may indicate a request for a mapping of the implicit indications to indications of one or more communication parameters.

As shown by reference number 615, the UE may receive, and the network node may transmit, an indication of a mapping of the implicit indication to indications of one or more communication parameters. For example, the network node may indicate a mapping of different amounts of information to provide in the CSI report to one or more indications of an uplink control channel resource, a repetition factor for an uplink control channel, a single-TRP operation mode or a multi-TRP operation mode, an indication of a DRX mode or a non-DRX mode, and/or an indication of a configuration of the DRX mode, among other examples. Additionally, or alternatively, the network node may indicate a mapping of a change of the different amounts of information to provide in the CSI report to changes in one or more indications of an uplink control channel resource, a repetition factor for an uplink control channel, a single-TRP operation mode or a multi-TRP operation mode, an indication of a DRX mode or a non-DRX mode, and/or an indication of a configuration of the DRX mode, among other examples.

As shown by reference number 620, the UE may receive, and the network node may transmit, an indication of a CSI report configuration and/or an explicit indication of an amount of information to provide in the CSI report. In some aspects, the explicit indication of the amount of information may be a coarse indication, from which an implicit indication may refine the amount of information to provide in the CSI report. For example, the explicit indication may indicate to provide an amount of information associated with network node-based beam prediction or to provide an amount of information associated with UE-based beam prediction. In some aspects, the explicit indication may be included in the CSI report configuration.

In some aspects, the network node may transmit the explicit indication and/or the indication of the configuration of the CSI report via a MAC CE that activates the CSI report, a CSI triggering state configuration that triggers the CSI report, or a CSI resource configuration that configures the CSI report.

As shown by reference number 625, the UE may receive, and the network node may transmit, an implicit indication of the amount of information to provide in the CSI report. In some aspects, the UE may receive the implicit indication of the amount of information in a first message that is different from a second message that schedules transmission of the CSI report (e.g., the indication described in connection with reference number 620).

In some aspects, the implicit indication may include an indication of a different communication parameter (e.g., not explicitly indicating a configuration of the CSI report). For example, the implicit indication may include an indication of an uplink control channel resource, an indication of a repetition factor for an uplink control channel, an indication of a single-TRP operation mode or a multi-TRP operation mode, an indication of a DRX mode or a non-DRX mode, and/or an indication of a configuration of the DRX mode, among other examples. Additionally, or alternatively, the implicit indication may indicate a change of an amount of information to provide in the CSI report based at least in part on one or more indications of a change to an uplink control channel resource, a repetition factor for an uplink control channel, a single-TRP operation mode or a multi-TRP operation mode, an indication of a DRX mode or a non-DRX mode, and/or an indication of a configuration of the DRX mode, among other examples. For example, the implicit indication may indicate a change from a first candidate amount of information to a second candidate amount of information.

In some aspects, the implicit indication of the amount of information is selected from a set of candidate amounts of information. In this way, the implicit indication may map to one of the set of candidate amounts of information. For example, the set of candidate amounts of information comprises a first candidate amount of information and a second candidate amount of information. The first candidate amount of information may be associated with a UE-based beam prediction and the second candidate amount of information may be associated with a network node-based beam prediction. The first candidate amount of information may be associated with a first number of channel measurement resources (CMRs) and the second candidate amount of information may be associated with a second number of CMRs. In some aspects, the first candidate amount of information may be associated with a first amount of reporting overhead and the second candidate amount of information may be associated with a second amount of reporting overhead. In some aspects, the second candidate amount of information may be associated with reporting predicted signal strengths for one or more CMRs.

In some aspects, the implicit indication may indicate a number of pairs of signal strengths and CMR identifiers to include in the CSI report, a number of pairs of signal strengths and identifiers associated with CMRs and reception beams to include in the CSI report, a number of pairs of SINRs and the CMR identifiers to include in the CSI report, and/or a number of pairs of SINRs and identifiers associated with the CMRs and reception beams to include in the CSI report. In some aspects, the implicit indication may indicate a signal strength quantization scheme to use in the CSI report, an SINR quantization scheme to use in the CSI report, and/or a compression scheme to use in the CSI report, among other examples.

As shown by reference number 630, the UE may receive, and the network node may transmit, reference signals. The UE may measure the reference signals to determine L1 information for beams associated with the reference signals. For example, the UE may obtain RSRP and/or SINR measurements for beams based at least in part on the reference signals.

As shown by reference number 635, the UE may perform UE-based beam prediction. In some aspects, the UE may perform UE-based beam prediction based at least in part on the explicit indication or the implicit indication indicating that the UE is to perform UE-based beam prediction. Alternatively, the UE may not perform UE-based beam prediction based at least in part on the explicit indication or the implicit indication indicating that the UE is not to perform UE-based beam prediction. The explicit indication or the implicit indication may indicate whether the UE is to perform UE-based beam prediction based at least in part on indicating an amount of data to provide in the CSI report. For example, an indication to provide an amount of data that satisfies a first threshold (e.g., at or below the threshold) may be associated with performing UE-based beam selection. Alternatively, an indication to provide an amount of data that satisfies a second threshold (e.g., at or above the threshold) may be associated with not performing UE-based beam selection.

As shown by reference number 640, the UE may generate the CSI report based at least in part on the implicit indication. Additionally, or alternatively, the UE may generate the CSI report based at least in part on the explicit indication. For example, an amount of information and/or one or more types of information provided in the CSI report may be based at least in part on the implicit indication and/or the explicit indication.

As shown by reference number 645, the UE may transmit, and the network node may receive, the CSI report having the amount of information as indicated by the implicit indication. For example, the UE may transmit the CSI report based at least in part on generation of the CSI report described in connection with reference number 640.

As shown by reference number 650, the network node may perform network node-based beam prediction based at least in part on the CSI report. In some aspects, the network node may perform network node-based beam prediction based at least in part on the amount of information included in the CSI report and/or whether the UE performed UE-based beam prediction, as described in connection with reference number 635.

Based at least in part on supporting changing amounts of information to be included in a CSI report, a network may efficiently use network node-based beam prediction and UE-based beam prediction. In this way, the UE and the network node may conserve network resources that may have otherwise been used to avoid beam prediction, may conserve power resources that may have otherwise been unnecessarily used by statically configuring UE-side beam prediction, and/or may conserve network resources that may have otherwise been unnecessarily used by using network node-based beam prediction with reduced accuracy from having insufficient information from a UE.

As indicated above, FIG. 6 is provided as an example. Other examples may differ from what is described with respect to FIG. 6.

FIG. 7 is a diagram illustrating an example process 700 performed, for example, by a UE, in accordance with the present disclosure. Example process 700 is an example where the UE (e.g., UE 120) performs operations associated with techniques for providing channel state information report information.

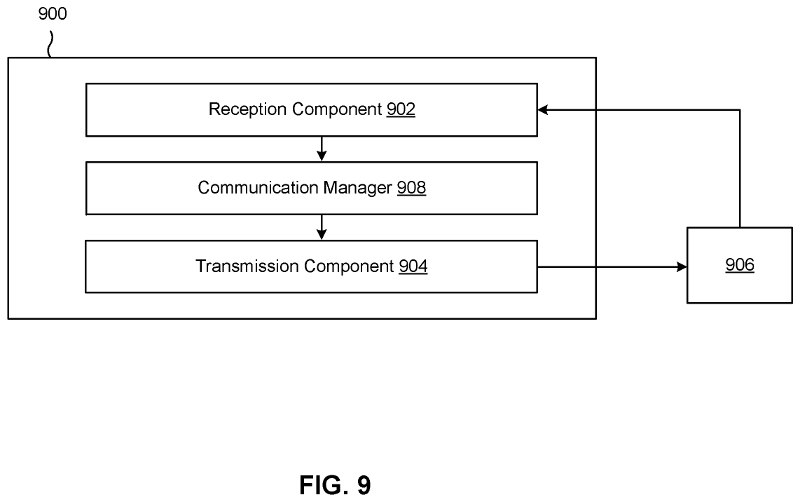

As shown in FIG. 7, in some aspects, process 700 may include receiving an indication of an amount of information to provide in a CSI report, the indication comprising an implicit indication of the amount of information in a first message that is different from a second message that schedules transmission of the CSI report (block 710). For example, the UE (e.g., using communication manager 140 and/or reception component 902, depicted in FIG. 9) may receive an indication of an amount of information to provide in a CSI report, the indication comprising an implicit indication of the amount of information in a first message that is different from a second message that schedules transmission of the CSI report, as described above.

As further shown in FIG. 7, in some aspects, process 700 may include transmitting the CSI report having the amount of information as indicated by the implicit indication (block 720). For example, the UE (e.g., using communication manager 140 and/or transmission component 904, depicted in FIG. 9) may transmit the CSI report having the amount of information as indicated by the implicit indication, as described above.

Process 700 may include additional aspects, such as any single aspect or any combination of aspects described below and/or in connection with one or more other processes described elsewhere herein.

In a first aspect, the implicit indication of the amount of information is selected from a set of candidate amounts of information, and the set of candidate amounts of information comprises first candidate amount of information and a second candidate amount of information.

In a second aspect, alone or in combination with the first aspect, the first candidate amount of information is associated with a UE-based beam prediction and the second candidate amount of information is associated with a network node-based beam prediction, wherein the first candidate amount of information is associated with a first number of CMRs and the second candidate amount of information is associated with a second number of CMRs, wherein the first candidate amount of information is associated with a first amount of reporting overhead and the second candidate amount of information is associated with a second amount of reporting overhead, or wherein the second candidate amount of information is associated with reporting predicted signal strengths for one or more CMRs.

In a third aspect, alone or in combination with one or more of the first and second aspects, process 700 includes receiving an explicit indication associated with the amount of information, wherein the explicit indication is in a different communication from the implicit indication, and wherein the amount of information is based at least in part on the explicit indication and the implicit indication.

In a fourth aspect, alone or in combination with one or more of the first through third aspects, reception of the explicit indication comprises receiving the explicit indication via a medium access control (MAC) control element (CE) that activates the CSI report, receiving the explicit indication via a CSI triggering state configuration that triggers the CSI report, or receiving the explicit indication via a CSI resource configuration that configures the CSI report.

In a fifth aspect, alone or in combination with one or more of the first through fourth aspects, the implicit indication of the amount of information indicates one or more of a number of pairs of signal strengths and channel measurement resource (CMR) identifiers to include in the CSI report, a number of pairs of signal strengths and identifiers associated with CMRs and reception beams to include in the CSI report, a number of pairs of signal-to-interference-plus-noise ratios (SINRs) and the CMR identifiers to include in the CSI report, a number of pairs of SINRs and identifiers associated with the CMRs and reception beams to include in the CSI report, a signal strength quantization scheme to use in the CSI report, an SINR quantization scheme to use in the CSI report, or a compression scheme to use in the CSI report.

In a sixth aspect, alone or in combination with one or more of the first through fifth aspects, the implicit indication comprises one or more of an indication of an uplink control channel resource, an indication of a repetition factor for an uplink control channel, an indication of a single transmission and reception point (single-TRP) operation mode or a multi-TRP operation mode, an indication of a discontinuous reception (DRX) mode or a non-DRX mode, or an indication of a configuration of the DRX mode.

In a seventh aspect, alone or in combination with one or more of the first through sixth aspects, the implicit indication comprises one or more of an indication of a change in uplink control channel resource, an indication of a change in repetition factor for an uplink control channel, an indication of a change between a single-TRP operation mode and a multi-TRP operation mode, an indication of a change between a DRX mode and a non-DRX mode, or an indication of a change in a configuration of the DRX mode.

In an eighth aspect, alone or in combination with one or more of the first through seventh aspects, the implicit indication indicates a change in the amount of information from a first candidate amount of information to a second candidate amount of information.

In a ninth aspect, alone or in combination with one or more of the first through eighth aspects, process 700 includes transmitting an indication of support for reception of implicit indications of amounts of information to provide in CSI reports.

In a tenth aspect, alone or in combination with one or more of the first through ninth aspects, process 700 includes receiving an indication of a mapping of implicit indications to indications of one or more communication parameters.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

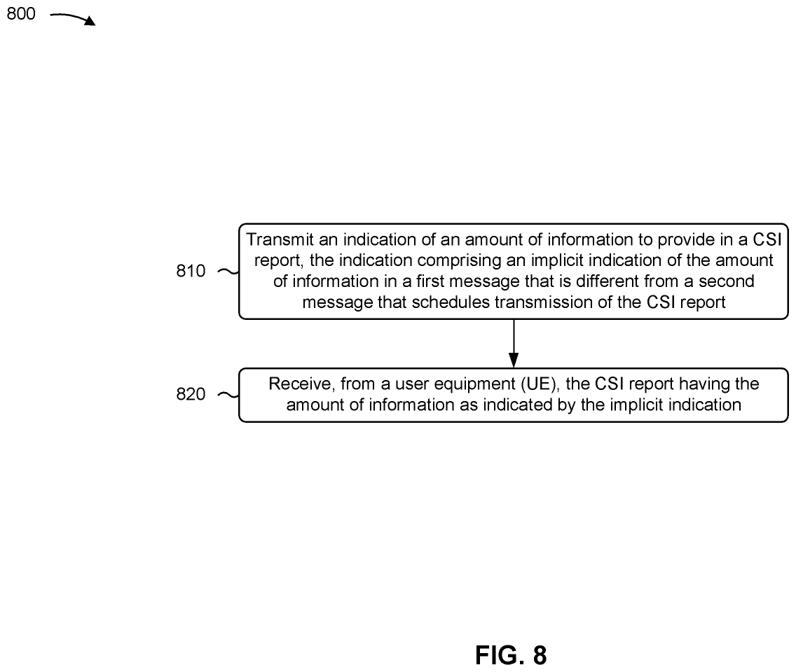

FIG. 8 is a diagram illustrating an example process 800 performed, for example, by a network node, in accordance with the present disclosure. Example process 800 is an example where the network node (e.g., network node 110) performs operations associated with techniques for providing channel state information report information.

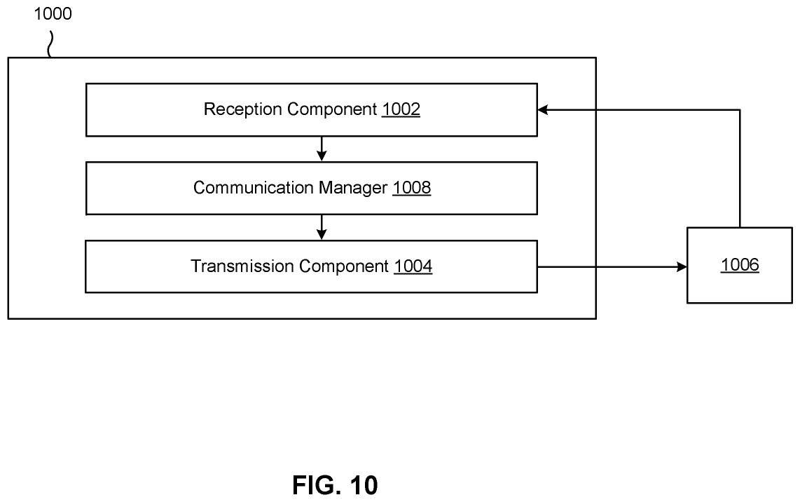

As shown in FIG. 8, in some aspects, process 800 may include transmitting an indication of an amount of information to provide in a CSI report, the indication comprising an implicit indication of the amount of information in a first message that is different from a second message that schedules transmission of the CSI report (block 810). For example, the network node (e.g., using communication manager 150 and/or transmission component 1004, depicted in FIG. 10) may transmit an indication of an amount of information to provide in a CSI report, the indication comprising an implicit indication of the amount of information in a first message that is different from a second message that schedules transmission of the CSI report, as described above.

As further shown in FIG. 8, in some aspects, process 800 may include receiving, from a UE, the CSI report having the amount of information as indicated by the implicit indication (block 820). For example, the network node (e.g., using communication manager 150 and/or reception component 1002, depicted in FIG. 10) may receive, from a UE, the CSI report having the amount of information as indicated by the implicit indication, as described above.

Process 800 may include additional aspects, such as any single aspect or any combination of aspects described below and/or in connection with one or more other processes described elsewhere herein.

In a first aspect, the implicit indication of the amount of information is selected from a set of candidate amounts of information, and the set of candidate amounts of information comprises first candidate amount of information and a second candidate amount of information.

In a second aspect, alone or in combination with the first aspect, the first candidate amount of information is associated with a UE-based beam prediction and the second candidate amount of information is associated with a network node-based beam prediction, wherein the first candidate amount of information is associated with a first number of CMRs and the second candidate amount of information is associated with a second number of CMRs, wherein the first candidate amount of information is associated with a first amount of reporting overhead and the second candidate amount of information is associated with a second amount of reporting overhead, or wherein the second candidate amount of information is associated with reporting predicted signal strengths for one or more CMRs.

In a third aspect, alone or in combination with one or more of the first and second aspects, process 800 includes transmitting an explicit indication associated with the amount of information, wherein the explicit indication is in a different communication from the implicit indication, and wherein the amount of information is based at least in part on the explicit indication and the implicit indication.

In a fourth aspect, alone or in combination with one or more of the first through third aspects, transmission of the explicit indication comprises transmitting the explicit indication via a MAC CE that activates the CSI report, transmitting the explicit indication via a CSI triggering state configuration that triggers the CSI report, or transmitting the explicit indication via a CSI resource configuration that configures the CSI report.

In a fifth aspect, alone or in combination with one or more of the first through fourth aspects, the implicit indication of the amount of information indicates one or more of a number of pairs of signal strengths and CMR identifiers to include in the CSI report, a number of pairs of signal strengths and identifiers associated with CMRs and reception beams to include in the CSI report, a number of pairs of SINRs and the CMR identifiers to include in the CSI report, a number of pairs of SINRs and identifiers associated with the CMRs and reception beams to include in the CSI report, a signal strength quantization scheme to use in the CSI report, an SINR quantization scheme to use in the CSI report, or a compression scheme to use in the CSI report.

In a sixth aspect, alone or in combination with one or more of the first through fifth aspects, the implicit indication comprises one or more of an indication of an uplink control channel resource, an indication of a repetition factor for an uplink control channel, an indication of a single-TRP operation mode or a multi-TRP operation mode, an indication of a DRX mode or a non-DRX mode, or an indication of a configuration of the DRX mode.

In a seventh aspect, alone or in combination with one or more of the first through sixth aspects, the implicit indication comprises one or more of an indication of a change in uplink control channel resource, an indication of a change in repetition factor for an uplink control channel, an indication of a change between a single-TRP operation mode and a multi-TRP operation mode, an indication of a change between a DRX mode and a non-DRX mode, or an indication of a change in a configuration of the DRX mode.

In an eighth aspect, alone or in combination with one or more of the first through seventh aspects, the implicit indication indicates a change in the amount of information from a first candidate amount of information to a second candidate amount of information.

In a ninth aspect, alone or in combination with one or more of the first through eighth aspects, process 800 includes receiving an indication of support for reception of implicit indications of amounts of information to provide in CSI reports.

In a tenth aspect, alone or in combination with one or more of the first through ninth aspects, process 800 includes transmitting an indication of a mapping of implicit indications to indications of one or more communication parameters.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include a communication manager 908 (e.g., the communication manager 140).

In some aspects, the apparatus 900 may be configured to perform one or more operations described herein in connection with FIG. 6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The reception component 902 may receive an indication of an amount of information to provide in a CSI report, the indication comprising an implicit indication of the amount of information in a first message that is different from a second message that schedules transmission of the CSI report. The transmission component 904 may transmit the CSI report having the amount of information as indicated by the implicit indication.

The reception component 902 may receive an explicit indication associated with the amount of information, wherein the explicit indication is in a different communication from the implicit indication, and wherein the amount of information is based at least in part on the explicit indication and the implicit indication.

The transmission component 904 may transmit an indication of support for reception of implicit indications of amounts of information to provide in CSI reports.

The reception component 902 may receive an indication of a mapping of implicit indications to indications of one or more communication parameters.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network node, or a network node may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include a communication manager 1008 (e.g., the communication manager 150.

In some aspects, the apparatus 1000 may be configured to perform one or more operations described herein in connection with FIG. 6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the network node described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the network node described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the network node described in connection with FIG. 2. In some aspects, the transmission component 1004 may be co-located with the reception component 1002 in a transceiver.

The transmission component 1004 may transmit an indication of an amount of information to provide in a CSI report, the indication comprising an implicit indication of the amount of information in a first message that is different from a second message that schedules transmission of the CSI report. The reception component 1002 may receive, from a UE, the CSI report having the amount of information as indicated by the implicit indication.

The transmission component 1004 may transmit an explicit indication associated with the amount of information, wherein the explicit indication is in a different communication from the implicit indication, and wherein the amount of information is based at least in part on the explicit indication and the implicit indication.

The reception component 1002 may receive an indication of support for reception of implicit indications of amounts of information to provide in CSI reports.

The transmission component 1004 may transmit an indication of a mapping of implicit indications to indications of one or more communication parameters.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:
Aspect 1: A method of wireless communication performed by a user equipment (UE), comprising: receiving an indication of an amount of information to provide in a channel state information (CSI) report, the indication comprising an implicit indication of the amount of information in a first message that is different from a second message that schedules transmission of the CSI report; and transmitting the CSI report having the amount of information as indicated by the implicit indication.
Aspect 2: The method of Aspect 1, wherein the implicit indication of the amount of information is selected from a set of candidate amounts of information, and wherein the set of candidate amounts of information comprises first candidate amount of information and a second candidate amount of information.
Aspect 3: The method of Aspect 2, wherein the first candidate amount of information is associated with a UE-based beam prediction and the second candidate amount of information is associated with a network node-based beam prediction, wherein the first candidate amount of information is associated with a first number of channel measurement resources (CMRs) and the second candidate amount of information is associated with a second number of CMRs, wherein the first candidate amount of information is associated with a first amount of reporting overhead and the second candidate amount of information is associated with a second amount of reporting overhead, or wherein the second candidate amount of information is associated with reporting predicted signal strengths for one or more CMRs.
Aspect 4: The method of any of Aspects 1-3, further comprising: receiving an explicit indication associated with the amount of information, wherein the explicit indication is in a different communication from the implicit indication, and wherein the amount of information is based at least in part on the explicit indication and the implicit indication.
Aspect 5: The method of Aspect 4, wherein reception of the explicit indication comprises: receiving the explicit indication via a medium access control (MAC) control element (CE) that activates the CSI report, receiving the explicit indication via a CSI triggering state configuration that triggers the CSI report, or receiving the explicit indication via a CSI resource configuration that configures the CSI report.
Aspect 6: The method of any of Aspects 1-5, wherein the implicit indication of the amount of information indicates one or more of: a number of pairs of signal strengths and channel measurement resource (CMR) identifiers to include in the CSI report, a number of pairs of signal strengths and identifiers associated with CMRs and reception beams to include in the CSI report, a number of pairs of signal-to-interference-plus-noise ratios (SINRs) and the CMR identifiers to include in the CSI report, a number of pairs of SINRs and identifiers associated with the CMRs and reception beams to include in the CSI report, a signal strength quantization scheme to use in the CSI report, an SINR quantization scheme to use in the CSI report, or a compression scheme to use in the CSI report.
Aspect 7: The method of any of Aspects 1-6, wherein the implicit indication comprises one or more of: an indication of an uplink control channel resource, an indication of a repetition factor for an uplink control channel, an indication of a single transmission and reception point (single-TRP) operation mode or a multi-TRP operation mode, an indication of a discontinuous reception (DRX) mode or a non-DRX mode, or an indication of a configuration of the DRX mode.
Aspect 8: The method of any of Aspects 1-7, wherein the implicit indication comprises one or more of: an indication of a change in uplink control channel resource, an indication of a change in repetition factor for an uplink control channel, an indication of a change between a single transmission and reception point (single-TRP) operation mode and a multi-TRP operation mode, an indication of a change between a discontinuous reception (DRX) mode and a non-DRX mode, or an indication of a change in a configuration of the DRX mode.
Aspect 9: The method of Aspect 8, wherein the implicit indication indicates a change in the amount of information from a first candidate amount of information to a second candidate amount of information.
Aspect 10: The method of any of Aspects 1-9, further comprising: transmitting an indication of support for reception of implicit indications of amounts of information to provide in CSI reports.
Aspect 11: The method of any of Aspects 1-10, further comprising: receiving an indication of a mapping of implicit indications to indications of one or more communication parameters.
Aspect 12: A method of wireless communication performed by a network node, comprising: transmitting an indication of an amount of information to provide in a channel state information (CSI) report, the indication comprising an implicit indication of the amount of information in a first message that is different from a second message that schedules transmission of the CSI report; and receiving, from a user equipment (UE), the CSI report having the amount of information as indicated by the implicit indication.
Aspect 13: The method of Aspect 12, wherein the implicit indication of the amount of information is selected from a set of candidate amounts of information, and wherein the set of candidate amounts of information comprises first candidate amount of information and a second candidate amount of information.
Aspect 14: The method of Aspect 13, wherein the first candidate amount of information is associated with a UE-based beam prediction and the second candidate amount of information is associated with a network node-based beam prediction, wherein the first candidate amount of information is associated with a first number of channel measurement resources (CMRs) and the second candidate amount of information is associated with a second number of CMRs, wherein the first candidate amount of information is associated with a first amount of reporting overhead and the second candidate amount of information is associated with a second amount of reporting overhead, or wherein the second candidate amount of information is associated with reporting predicted signal strengths for one or more CMRs.
Aspect 15: The method of any of Aspects 12-14, further comprising: transmitting an explicit indication associated with the amount of information, wherein the explicit indication is in a different communication from the implicit indication, and wherein the amount of information is based at least in part on the explicit indication and the implicit indication.
Aspect 16: The method of Aspect 15, wherein transmission of the explicit indication comprises: transmitting the explicit indication via a medium access control (MAC) control element (CE) that activates the CSI report, transmitting the explicit indication via a CSI triggering state configuration that triggers the CSI report, or transmitting the explicit indication via a CSI resource configuration that configures the CSI report.
Aspect 17: The method of any of Aspects 12-16, wherein the implicit indication of the amount of information indicates one or more of: a number of pairs of signal strengths and channel measurement resource (CMR) identifiers to include in the CSI report, a number of pairs of signal strengths and identifiers associated with CMRs and reception beams to include in the CSI report, a number of pairs of signal-to-interference-plus-noise ratios (SINRs) and the CMR identifiers to include in the CSI report, a number of pairs of SINRs and identifiers associated with the CMRs and reception beams to include in the CSI report, a signal strength quantization scheme to use in the CSI report, an SINR quantization scheme to use in the CSI report, or a compression scheme to use in the CSI report.
Aspect 18: The method of any of Aspects 12-17, wherein the implicit indication comprises one or more of: an indication of an uplink control channel resource, an indication of a repetition factor for an uplink control channel, an indication of a single transmission and reception point (single-TRP) operation mode or a multi-TRP operation mode, an indication of a discontinuous reception (DRX) mode or a non-DRX mode, or an indication of a configuration of the DRX mode.
Aspect 19: The method of any of Aspects 12-18, wherein the implicit indication comprises one or more of: an indication of a change in uplink control channel resource, an indication of a change in repetition factor for an uplink control channel, an indication of a change between a single transmission and reception point (single-TRP) operation mode and a multi-TRP operation mode, an indication of a change between a discontinuous reception (DRX) mode and a non-DRX mode, or an indication of a change in a configuration of the DRX mode.
Aspect 20: The method of Aspect 19, wherein the implicit indication indicates a change in the amount of information from a first candidate amount of information to a second candidate amount of information.
Aspect 21: The method of any of Aspects 12-20, further comprising: receiving an indication of support for reception of implicit indications of amounts of information to provide in CSI reports.
Aspect 22: The method of any of Aspects 12-21, further comprising: transmitting an indication of a mapping of implicit indications to indications of one or more communication parameters.
Aspect 23: An apparatus for wireless communication at a device, comprising a processor; memory coupled with the processor; and instructions stored in the memory and executable by the processor to cause the apparatus to perform the method of one or more of Aspects 1-22.
Aspect 24: A device for wireless communication, comprising a memory and one or more processors coupled to the memory, the one or more processors configured to perform the method of one or more of Aspects 1-22.
Aspect 25: An apparatus for wireless communication, comprising at least one means for performing the method of one or more of Aspects 1-22.
Aspect 26: A non-transitory computer-readable medium storing code for wireless communication, the code comprising instructions executable by a processor to perform the method of one or more of Aspects 1-22.
Aspect 27: A non-transitory computer-readable medium storing a set of instructions for wireless communication, the set of instructions comprising one or more instructions that, when executed by one or more processors of a device, cause the device to perform the method of one or more of Aspects 1-22.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. A method of wireless communication performed by a user equipment (UE), comprising:
receiving an indication of an amount of information to provide in a channel state information (CSI) report, the indication comprising an implicit indication of the amount of information in a first message that is different from a second message that schedules transmission of the CSI report; and
transmitting the CSI report having the amount of information as indicated by the implicit indication.

2. The method of claim 1, wherein the implicit indication of the amount of information is selected from a set of candidate amounts of information, and
wherein the set of candidate amounts of information comprises first candidate amount of information and a second candidate amount of information.

3. The method of claim 2, wherein the first candidate amount of information is associated with a UE-based beam prediction and the second candidate amount of information is associated with a network node-based beam prediction,
wherein the first candidate amount of information is associated with a first number of channel measurement resources (CMRs) and the second candidate amount of information is associated with a second number of CMRs,
wherein the first candidate amount of information is associated with a first amount of reporting overhead and the second candidate amount of information is associated with a second amount of reporting overhead, or
wherein the second candidate amount of information is associated with reporting predicted signal strengths for one or more CMRs.

4. The method of claim 1, further comprising:
receiving an explicit indication associated with the amount of information,
wherein the explicit indication is in a different communication from the implicit indication, and
wherein the amount of information is based at least in part on the explicit indication and the implicit indication.

5. The method of claim 4, wherein reception of the explicit indication comprises:
receiving the explicit indication via a medium access control (MAC) control element (CE) that activates the CSI report,
receiving the explicit indication via a CSI triggering state configuration that triggers the CSI report, or
receiving the explicit indication via a CSI resource configuration that configures the CSI report.

6. The method of claim 1, wherein the implicit indication of the amount of information indicates one or more of:
a number of pairs of signal strengths and channel measurement resource (CMR) identifiers to include in the CSI report,
a number of pairs of signal strengths and identifiers associated with CMRs and reception beams to include in the CSI report,
a number of pairs of signal-to-interference-plus-noise ratios (SINRs) and the CMR identifiers to include in the CSI report,
a number of pairs of SINRs and identifiers associated with the CMRs and reception beams to include in the CSI report,
a signal strength quantization scheme to use in the CSI report,
an SINR quantization scheme to use in the CSI report, or
a compression scheme to use in the CSI report.

7. The method of claim 1, wherein the implicit indication comprises one or more of:
an indication of an uplink control channel resource,
an indication of a repetition factor for an uplink control channel,
an indication of a single transmission and reception point (single-TRP) operation mode or a multi-TRP operation mode,
an indication of a discontinuous reception (DRX) mode or a non-DRX mode, or
an indication of a configuration of the DRX mode.

8. The method of claim 1, wherein the implicit indication comprises one or more of:
an indication of a change in uplink control channel resource,
an indication of a change in repetition factor for an uplink control channel,
an indication of a change between a single transmission and reception point (single-TRP) operation mode and a multi-TRP operation mode,
an indication of a change between a discontinuous reception (DRX) mode and a non-DRX mode, or
an indication of a change in a configuration of the DRX mode.

9. The method of claim 8, wherein the implicit indication indicates a change in the amount of information from a first candidate amount of information to a second candidate amount of information.

10. The method of claim 1, further comprising:
transmitting an indication of support for reception of implicit indications of amounts of information to provide in CSI reports.

11. The method of claim 1, further comprising:
receiving an indication of a mapping of implicit indications to indications of one or more communication parameters.

12. A method of wireless communication performed by a network node, comprising:
transmitting an indication of an amount of information to provide in a channel state information (CSI) report, the indication comprising an implicit indication of the amount of information in a first message that is different from a second message that schedules transmission of the CSI report; and
receiving, from a user equipment (UE), the CSI report having the amount of information as indicated by the implicit indication.

13. The method of claim 12, wherein the implicit indication of the amount of information is selected from a set of candidate amounts of information, and
wherein the set of candidate amounts of information comprises first candidate amount of information and a second candidate amount of information.

14. The method of claim 13, wherein the first candidate amount of information is associated with a UE-based beam prediction and the second candidate amount of information is associated with a network node-based beam prediction,
wherein the first candidate amount of information is associated with a first number of channel measurement resources (CMRs) and the second candidate amount of information is associated with a second number of CMRs,
wherein the first candidate amount of information is associated with a first amount of reporting overhead and the second candidate amount of information is associated with a second amount of reporting overhead, or
wherein the second candidate amount of information is associated with reporting predicted signal strengths for one or more CMRs.

15. The method of claim 12, further comprising:
transmitting an explicit indication associated with the amount of information,
wherein the explicit indication is in a different communication from the implicit indication, and
wherein the amount of information is based at least in part on the explicit indication and the implicit indication.

16. The method of claim 15, wherein transmission of the explicit indication comprises:
transmitting the explicit indication via a medium access control (MAC) control element (CE) that activates the CSI report,
transmitting the explicit indication via a CSI triggering state configuration that triggers the CSI report, or
transmitting the explicit indication via a CSI resource configuration that configures the CSI report.

17. The method of claim 12, wherein the implicit indication of the amount of information indicates one or more of:
a number of pairs of signal strengths and channel measurement resource (CMR) identifiers to include in the CSI report,
a number of pairs of signal strengths and identifiers associated with CMRs and reception beams to include in the CSI report,
a number of pairs of signal-to-interference-plus-noise ratios (SINRs) and the CMR identifiers to include in the CSI report,
a number of pairs of SINRs and identifiers associated with the CMRs and reception beams to include in the CSI report,
a signal strength quantization scheme to use in the CSI report,
an SINR quantization scheme to use in the CSI report, or
a compression scheme to use in the CSI report.

18. The method of claim 12, wherein the implicit indication comprises one or more of:
an indication of an uplink control channel resource,
an indication of a repetition factor for an uplink control channel,
an indication of a single transmission and reception point (single-TRP) operation mode or a multi-TRP operation mode,
an indication of a discontinuous reception (DRX) mode or a non-DRX mode, or
an indication of a configuration of the DRX mode.

19. The method of claim 12, wherein the implicit indication comprises one or more of:
an indication of a change in uplink control channel resource,
an indication of a change in repetition factor for an uplink control channel,
an indication of a change between a single transmission and reception point (single-TRP) operation mode and a multi-TRP operation mode,
an indication of a change between a discontinuous reception (DRX) mode and a non-DRX mode, or
an indication of a change in a configuration of the DRX mode.

20. The method of claim 19, wherein the implicit indication indicates a change in the amount of information from a first candidate amount of information to a second candidate amount of information.

21. The method of claim 12, further comprising:
receiving an indication of support for reception of implicit indications of amounts of information to provide in CSI reports.

22. The method of claim 12, further comprising:
transmitting an indication of a mapping of implicit indications to indications of one or more communication parameters.

23. A user equipment (UE) for wireless communication, comprising:
a memory; and
one or more processors, coupled to the memory, configured to:
receive an indication of an amount of information to provide in a channel state information (CSI) report, the indication comprising an implicit indication of the amount of information in a first message that is different from a second message that schedules transmission of the CSI report; and
transmit the CSI report having the amount of information as indicated by the implicit indication.

24. The UE of claim 23, wherein the implicit indication of the amount of information is selected from a set of candidate amounts of information, and
wherein the set of candidate amounts of information comprises first candidate amount of information and a second candidate amount of information.

25. The UE of claim 24, wherein the first candidate amount of information is associated with a UE-based beam prediction and the second candidate amount of information is associated with a network node-based beam prediction,
wherein the first candidate amount of information is associated with a first number of channel measurement resources (CMRs) and the second candidate amount of information is associated with a second number of CMRs,
wherein the first candidate amount of information is associated with a first amount of reporting overhead and the second candidate amount of information is associated with a second amount of reporting overhead, or
wherein the second candidate amount of information is associated with reporting predicted signal strengths for one or more CMRs.

26. The UE of claim 23, wherein the one or more processors are further configured to:
receive an explicit indication associated with the amount of information,
wherein the explicit indication is in a different communication from the implicit indication, and
wherein the amount of information is based at least in part on the explicit indication and the implicit indication.

27. A network node for wireless communication, comprising:
a memory; and
one or more processors, coupled to the memory, configured to:
transmit an indication of an amount of information to provide in a channel state information (CSI) report, the indication comprising an implicit indication of the amount of information in a first message that is different from a second message that schedules transmission of the CSI report; and
receive, from a user equipment (UE), the CSI report having the amount of information as indicated by the implicit indication.

28. The network node of claim 27, wherein the implicit indication of the amount of information is selected from a set of candidate amounts of information, and
wherein the set of candidate amounts of information comprises first candidate amount of information and a second candidate amount of information.

29. The network node of claim 28, wherein the first candidate amount of information is associated with a UE-based beam prediction and the second candidate amount of information is associated with a network node-based beam prediction,
wherein the first candidate amount of information is associated with a first number of channel measurement resources (CMRs) and the second candidate amount of information is associated with a second number of CMRs,
wherein the first candidate amount of information is associated with a first amount of reporting overhead and the second candidate amount of information is associated with a second amount of reporting overhead, or
wherein the second candidate amount of information is associated with reporting predicted signal strengths for one or more CMRs.

30. The network node of claim 27, wherein the one or more processors are further configured to:
transmit an explicit indication associated with the amount of information,
wherein the explicit indication is in a different communication from the implicit indication, and
wherein the amount of information is based at least in part on the explicit indication and the implicit indication.
